(19) United States
(12) Patent Application Publication
(10) Pub. No.: US 2009/0269122 A1
(43) Pub. Date: Oct. 29, 2009

(54) INK REPLENISHMENT CARTRIDGE AND ENCAPSULATED FIBER TYPE WRITING INSTRUMENT USING INK REPLENISHMENT CARTRIDGE

(75) Inventor: Morio Akiyama, Kanagawa-ken (JP)

Correspondence Address: GREENBLUM & BERNSTEIN, P.L.C., 1950 ROLAND CLARKE PLACE, RESTON, VA, 20191, US

(73) Assignee: ZEBRA CO., LTD., Tokyo (JP)

(21) Appl. No.: 12/095,365

(22) PCT Filed: Nov. 30, 2005
(86) PCT No.: PCT/JP2005/022018

§ 371 Date: May 29, 2008

(51) Int. Cl. B43K 8/06; B43K 8/03; B43K 11/00

(52) U.S. Cl. 401/198; 401/203; 401/206

(57) ABSTRACT

The invention provides an ink replenishment cartridge and a writing instrument using the ink replenishment cartridge where new ink can be easily replenished in the writing instrument in which ink has been spent completely. The invention has a characteristic that the ink replenishment cartridge is provided with an ink tank having an ink discharge port, ink filled in the ink tank and a closing cap detachably mounted on the ink tank to close the ink discharge port and the ink tank is installed with the ink discharge port communicating with an opening at a rear end of a stem of the writing instrument from which a detachable tail cotter is removed.

### BACKGROUND OF THE INVENTION

1. Field of the Invention

The present invention relates to an ink replenishment cartridge for replenishing a writing instrument with ink, and particularly relates to an ink replenishment cartridge suitable for replenishing an encapsulated fiber type writing instrument provided with inner fiber in a stem with ink and the encapsulated fiber type writing instrument using the ink replenishment cartridge.

2. Description of the Related Art

As for a conventional type encapsulated fiber type writing instrument, as in an invention disclosed in Patent Laid-open Sho 61-42099, for example, inner fiber (a fiber bundle 5) folded in two is inserted into a stem (1) from an opening at its front end, a part left outside the stem (1) of the inner fiber (the fiber bundle 5) is impregnated with a setting agent, and after the setting agent is hardened, the part outside the stem (1) of the inner fiber (the fiber bundle 5) is cut to be a writing part (15b).

For another conventional type technique, as in an invention disclosed in Patent Laid-open No. 2003-63190, for example, an encapsulated fiber type writing instrument where inner fiber (11) in a stem (12) and a writing part (a pen 14) are separate and when ink is completely consumed, the spent inner fiber (11) can be replaced with new inner fiber filled with ink (inner fiber for replacement 21) is disclosed.

As the inner fiber is integrated with the writing part in the former encapsulated fiber type writing instrument, ink impregnated in the inner fiber can be smoothly supplied to the side of a front end of the writing part, compared with the latter encapsulated fiber type writing instrument where the inner fiber and the writing part are separate, and the former encapsulated fiber type writing instrument has advantages such as enough ink is discharged and writing is hardly patchy.

Meanwhile, in the former encapsulated fiber type writing instrument, since the inner fiber is encapsulated in the stem in a compressed condition and the writing part is worked in the part protruded outside the stem of the inner fiber, the spent inner fiber cannot be replaced with new inner fiber filled with ink as in the latter prior art even if ink is completely consumed and it is difficult to replenish ink.

### SUMMARY OF THE INVENTION

The invention is made in view of the above-mentioned situation and provides an ink replenishment cartridge that enables easily replenishing new ink in a writing instrument in which ink has been spent completely and a writing instrument using the ink replenishment cartridge.

To address the problem, a first invention has a characteristic that there are provided an ink tank having an ink discharge port, ink filled in the ink tank and a closing cap detachably mounted on the ink tank to close the ink discharge port and the ink tank is installed with the ink discharge port communicating with an opening at a rear end of a stem of a writing instrument from which a detachable tail cotter is removed.

In this case, a method of installing the ink tank in the opening at the rear end of the stem of the writing instrument may be fitting and screwing, and particularly from a viewpoint of facilitating attachment and detachment, it is desirable that the ink tank is screwed to the rear end of the stem of the writing instrument.

A second invention has a characteristic that the ink tank is inserted into the opening at the rear end of the stem of the writing instrument and the ink discharge port is touched to inner fiber in the stem.

A third invention has a characteristic that a small-diameter part is provided on the side of a front end of the ink tank, the ink discharge port is provided inside the small-diameter part, a vent is provided outside the small-diameter part and the vent is closed by the closing cap.

A fourth invention is based upon a writing instrument that enables attaching and detaching of the ink replenishment cartridge into/from the opening at the rear end of the stem when the tail cotter is removed and has a characteristic that inner fiber folded in two is encapsulated in the stem.

As the invention is configured as described above, the following action and effect are produced.

According to the first invention, when ink in the writing instrument has been spent completely, the tail cotter of the writing instrument is removed. Meanwhile, if the closing cap of the ink replenishment cartridge is also removed and the ink tank is installed in the opening at the rear end of the stem of the writing instrument, ink in the ink tank is supplied to the inside of the stem.

Therefore, ink is never spilt, a user's hand never becomes dirty, and ink can be easily replenished in the writing instrument.

In addition, as the ink replenishment cartridge is configured so that it is installed at the rear end of the stem of the writing instrument, installation space is not required in the stem, compared with an ink replenishment cartridge installed in a stem of a writing instrument for example. Therefore, it can also be easily installed in a relatively thinnish writing instrument.

Further, according to the second invention, ink is prevented from being left in the ink tank by surface tension and others when the ink is replenished in the stem of the writing instrument from the ink tank and ink can smoothly permeate the inner fiber from the ink tank.

Further, according to the third invention, in a state in which the closing cap is mounted, the ink discharge port and the vent can be closed by the closing cap.

When the ink tank is installed in the opening at the rear end of the stem of the writing instrument and ink is filled, air in the stem is guided into the ink tank via the vent as ink is discharged from the ink discharge port. Therefore, ink can be smoothly supplied to the stem from the ink tank.

Further, according to the fourth invention, a writing instrument in which inner fiber folded in two is encapsulated and it is difficult to replace the inner fiber can be changed to the writing instrument where ink can be easily replenished owing to the ink replenishment cartridge.

### BRIEF DESCRIPTION OF THE DRAWINGS

FIG. 1 is a sectional view showing one example of an ink replenishment cartridge according to the invention.

FIG. 2 is a sectional view showing one example of an encapsulated fiber type writing instrument using the ink replenishment cartridge according to the invention.

FIG. 3A is a sectional view showing a state before the ink replenishment cartridge is installed in a stem of the encapsulated fiber type writing instrument and FIG. 3B is a sectional view showing a state in which the ink replenishment cartridge is installed in the stem of the encapsulated fiber type writing instrument.

### DESCRIPTION OF THE PREFERRED EMBODIMENTS

Referring to the drawings, an embodiment of the invention will be described below.

This ink replenishment cartridge A is provided with an ink tank 10 having an ink discharge port 12b1, ink M filled in the ink tank 10, a closing cap 20 detachably mounted on the ink tank 10 to close the ink discharge port 12b1 and packing 30 provided between the ink tank 10 and the closing cap 20, and the ink replenishment cartridge is configured so an encapsulated fiber type writing instrument B described later can be replenished with ink M.

The ink tank 10 is integrally formed by a body 11 of the tank forming space for accumulating ink M and a discharge port member 12 forming the ink discharge port 12b1.

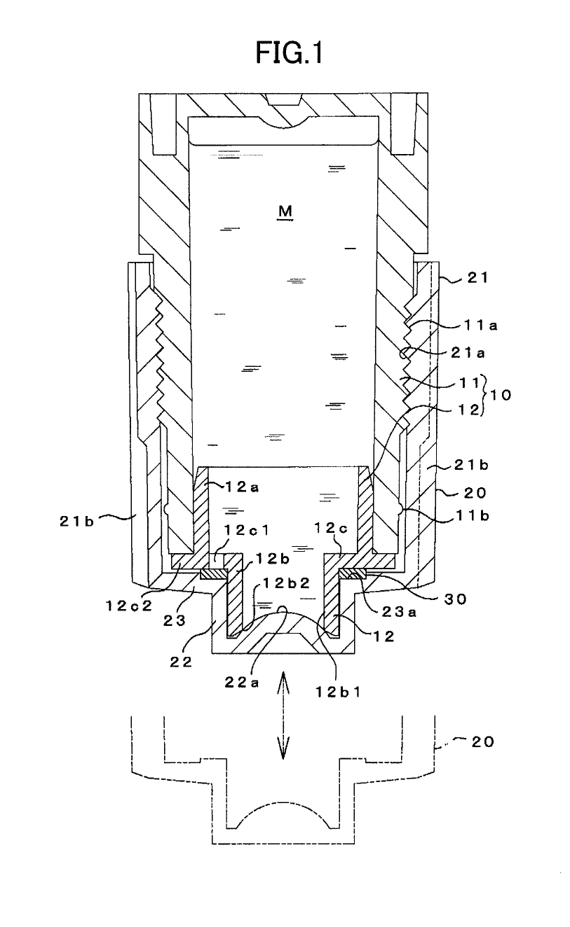

The body 11 of the tank is substantially in the shape of a cylinder with a bottom, is provided with a male screw 11a for screwing the closing cap 20 described later on its outside face, and is provided on the side of a front end (on the side of a lower end in FIG. 1) of the male screw 11a on the outside face with an annular projection 11b press-fitted to an inside face on the rear side of a stem 40 in the writing instrument B when the body is installed in the writing instrument B described later.

The male screw 11a is formed so that it is screwed to an opening at a rear end of the stem of the writing instrument B with the ink discharge port 12b1 communicating when a detachable tail cotter is detached from the writing instrument B described later.

The discharge port member 12 is fitted to the inside of an opening at a front end of the body 11 of the tank.

The discharge port member 12 is integrally formed by a substantially cylindrical press-fitted part 12a press-fitted to the opening at the front end of the body 11 of the tank, a small-diameter part 12b formed in a smaller diameter than an inside diameter of the press-fitted part 12a, and a joint 12c connecting the press-fitted part and the small-diameter part 12b.

The press-fitted part 12a is mounted on the body 11 of the tank fluidtight by press-fitting it to the opening at the front end of the body 11 of the tank. To further enhance fluid-tightness, a fluid-tight structure such as an annular protrusion may also be provided to an outside face of the press-fitted part 12a or an inside face of the body 11 of the tank.

The small-diameter part 12b is formed substantially in the shape of a cylinder the outside diameter of which is smaller than the inside diameter of the press-fitted part 12a and an opening on the side of its front end functions as the ink discharge port 12b1 for pushing ink M out.

The length of the small-diameter part 12b is suitably set so that a front end face of the small-diameter part 12b is inserted into the opening at the rear end of the stem of the writing instrument B described later and is touched to inner fiber 60 in the stem 40.

A corner part 12b2 is formed on a front end face of a circumferential wall of the small-diameter part 12b by chamfering the side of its inside face.

The corner part 12b2 closes the ink discharge port 12b1 fluidtight by touching the corner part to an inside face at a front end of the closing cap 20 overall.

The joint 12c is an annular part that connects a front end of the press-fitted part 12a and a rear end of the small-diameter part 12b and axially pierces a single or plural vents 12c1 (single in FIG. 1).

A peripheral part 12c2 of the joint 12c is formed in a larger outside diameter than the outside diameter of the press-fitted part 12a and is touched to the front end of the body 11 of the tank.

The closing cap 20 is formed to fit with the shape on the front end side of the ink tank 10, detailedly, includes a substantially cylindrical screwing cylinder 21 screwed on an outside face of the body 11 of the tank, a head 22 having a smaller diameter than a diameter of an inside face of the screwing cylinder 21 and formed substantially in the shape of a cylinder with a bottom and a packing pressing part 23 which is arranged to connect the head 22 and the screwing cylinder 21 and presses the packing 30 described later, and the packing 30 is fitted to an inside face of the packing pressing part 23.

The screwing cylinder 21 is provided with a female screw 21a to fit with the male screw 11a of the body 11 of the tank on the inside face.

Plural vertical ribs 21b that function as anantislipping member are protruded in a circumferential direction on an outside face of the screwing cylinder 21 to facilitate turning the closing cap 20 around the ink tank 10.

The head 22 is formed substantially in the shape of the cylinder with the bottom a front end face of which is closed, an inside face of the bottom is touched to the corner part 12b2 at a front end of the discharge port member 12, and a curved part 22a for holding the inside of the ink discharge port 12b1 fluidtight is formed.

The packing pressing part 23 is an annular part that connects the screwing cylinder 21 of the closing cap 20 with the head 22, and an annular concave portion 23a fitted to protrude the packing 30 described later backward is formed on its inside face.

The packing 30 is a member substantially in the shape of a washer made of an elastic body such as rubber and elastomer resin in an example shown in FIG. 1 and is compressed between the joint 12c of the discharge port member 12 and the packing pressing part 23 of the closing cap 20 to close the vent 12c1 of the discharge port member 12.

The packing 30 prevents ink M in the body 11 of the tank from leaking out via the vent 12c1 and if the ink M should leak out via clearance between the corner part 12b2 of the discharge port member 12 and the curved part 22a of the closing cap 20, the packing acts so that the ink M is prevented from flowing outside.

For an embodiment except the example shown in FIG. 1, the packing 30 in the shape of the washer may also be replaced with O ring.

Next, the encapsulated fiber type writing instrument B configured so that ink M is replenished by the ink replenishment cartridge A will be described in detail.

The encapsulated fiber type writing instrument B is provided with the substantially cylindrical stem 40, the inner fiber 60 inserted into the stem 40, the tail cotter 50 detachably mounted at a rear end of the stem 40 and a cap 70 detachably mounted at a front end of the stem 40, and the side of a front end of the inner fiber 60 is protruded from the front end of the stem 40 to be a writing part 61.

The encapsulated fiber type writing instrument B enables attaching and detaching of the ink replenishment cartridge A into/from the opening at the rear end of the stem when the tail cotter 50 is removed.

The stem 40 is integrally made of synthetic resin and is provided with the substantially cylindrical body 41 of the stem, a cap fitting part 42 arranged on the side of a front end of the body 41 and a tip 43 arranged further on the side of a front end of the cap fitting part 42.

A pair of vertical ribs 41a axially extended with the vertical ribs touched to the outside face of the inner fiber 60 are formed on the front side of an inside face of the body 41 of the stem and space between the pair of vertical ribs 41a functions as an air flowing groove 41d.

The pair of vertical ribs 41a prevents the side of the outside face of the inner fiber 60 from eating into the air flowing groove 41d between the pair of the vertical ribs 41a by arranging one vertical rib 41a close to the other vertical rib 41a.

The side of a front end of the air flowing groove 41d communicates with air flowing space s described later and the air flowing groove 41d makes air taken in from the outside via a vent 42c flow backward in the stem 40.

The plural pairs of vertical ribs 41a are arranged at a predetermined interval in a circumferential direction of the inside face of the body 41 of the stem.

A female screw 41b to which the tail cotter 50 and the ink tank 10 can be screwed is formed on the inside face of the rear end side of the body 41 of the stem.

A part on the front side of the female screw 41b of the inside face of the body 41 of the stem is an even press-fitted face 41c for press-fitting an annular projection 51 of the tail cotter 50 or the annular projection 11b of the ink tank 10.

The cap fitting part 42 is provided with an annular projection 42a for fitting the cap 70 over it on its outside face.

An inner fiber fixing cylinder 42b is formed inside the cap fitting part 42 via the annular air flowing space s.

The air flowing space s is extended forward in the stem and communicates with the vent 42c extended in a centrifugal direction of the stem on the way on the side of its front end.

The plural vents 42c are provided at a predetermined interval in the circumferential direction of the stem 40.

According to the configuration, in normal writing, air is taken in from the vent 42c according to the discharge of ink M from the writing part 61, is guided backward through the air flowing space s, is guided to the air flowing groove 41d between the pair of vertical ribs 41a, and further, can be guided to the outside face of the inner fiber 60.

Therefore, the inner fiber 60 smoothly discharges ink M, sucking the air taken in from the outside.

When ink M penetrates the air flowing space s by the application of the impact of a drop and others to the encapsulated fiber type writing instrument B, the ink M is prevented from flowing outside through the vent 42c by hitting the ink M on a front end face of the air flowing space s.

The tip 43 is formed substantially cylindrically with the tip connecting with the inner fiber fixing cylinder 42b.

An annular protrusion 43a is formed on an inside face of the tip 43 and a part except the annular protrusion 43a of the inside face is formed substantially in the same diameter as an inside face of the inner fiber fixing cylinder 42b.

The annular protrusion 43a is provided to press the outside face of the inner fiber 60, a flow rate of ink M flowing in the inner fiber 60 is adjusted to be appropriate, and a protruded dimension is set to an appropriate value to prevent the inner fiber 60 from being displaced in a longitudinal direction.

The inner fiber 60 is long fiber made of polyester fiber or others, the fiber swollen more than the content volume of the stem 40 is folded in two, and is press-fitted into the stem 40 from the front end side of the stem 40 with the folded part at the head.

In press-fitting, a part on the side of the front end (a part on the reverse side to the folded part) of the inner fiber 60 is left outside and the part on the side of the front end forms the writing part 61 described later.

No coating made of synthetic resin or others is applied to the outside face of the inner fiber 60.

The part on the side of the front end of the inner fiber 60 partially inserted into the stem 40 as described above is cut to be a suitable dimension and the cut inner fiber 60 is impregnated with a setting agent x made of urethane resin or others.

At this time, the setting agent x permeates the vicinity of the annular protrusion 43a on the side of the outside face on the front end side of the inner fiber 60.

The writing part 61 is formed by cutting the part on the front end side of the inner fiber 60 substantially in the shape of a shell after the setting agent x permeates as described above, is heated and is hardened.

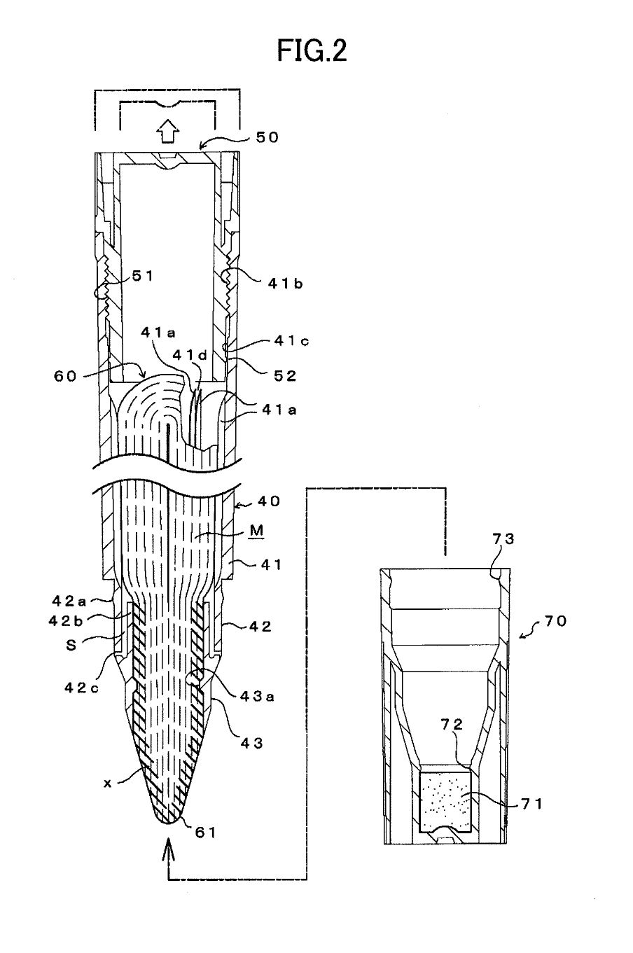

In an example shown in FIG. 2, a hatched part including the inner fiber fixing cylinder 42b on the front end side of the inner fiber fixing cylinder 42b is impregnated with the setting agent x.

According to the configuration, the vicinity of the annular protrusion 43a on the outside face side of the inner fiber 60 is impregnated with the setting agent x and is hardened, and further, restoring force that tries to restore the inner fiber to an original condition from a folded condition acts on the inner fiber 60.

Therefore, the annular protrusion 43a and the inner fiber 60 impregnated with the setting agent x and hardened are strongly fitted by the restoring force, and the inner fiber 60 and the writing part 61 can be prevented from being axially displaced by fitting.

After the writing part 61 is formed as described above, ink M is injected into the stem 40 from the opening at the rear end and the inner fiber 60 is impregnated with the ink M.

The tail cotter 50 is a cylindrical member with a bottom having the substantially same shape as the body 11 of the tank of the ink replenishment cartridge A, a male screw 51 and an annular projection 52 are formed on an outside face on the side of its front end, the male screw 51 is screwed to the female screw 41b of the stem 40, the annular projection 52 is press-fitted to the press-fitted face 41c of the stem 40, and the opening at the rear end of the stem 40 is closed.

The male screw 51 and the annular projection 52 are configured substantially in the same shape as the male screw 11a and the annular projection 11b respectively of the body 11 of the tank.

According to the tail cotter 50, the productivity of both the ink replenishment cartridge A and the encapsulated fiber type writing instrument B can be enhanced by forming the tail cotter 50 and the body 11 of the tank by common parts.

The cap 70 is a substantially cylindrical member with a bottom for covering the cap fitting part 42, the tip 43 and the writing part 61 respectively on the front end side of the stem 40, and a drying prevention member 71 made of water absorption material such as polyurethane foam is inserted at the bottom to prevent the drying of a front end of the writing part 61.

The drying prevention member 71 is fitted by an annular protrusion 72 on the front end side of an inside face of the cap 70 to prevent the drying prevention member from being displaced backward.

An annular protrusion 73 for fitting the cap to the cap fitting part 42 over the annular projection 42a is formed on the inside face on the rear end side of the cap 70.

Next, a procedure for replenishing ink M in the encapsulated fiber type writing instrument B by the ink replenishment cartridge A will be described in detail.

First, the tail cotter 50 is removed from the stem 40 of the encapsulated fiber type writing instrument B. At this time, the tail cotter 50 can be easily removed from the stem 40 by turning the tail cotter 50 in a reverse direction to a screwed direction with the stem 40 fixed.

In the meantime, as for the ink replenishment cartridge A, the closing cap 20 is removed from the ink tank 10.

The ink tank 10 is installed in the stem 40 from which the tail cotter 50 is removed.

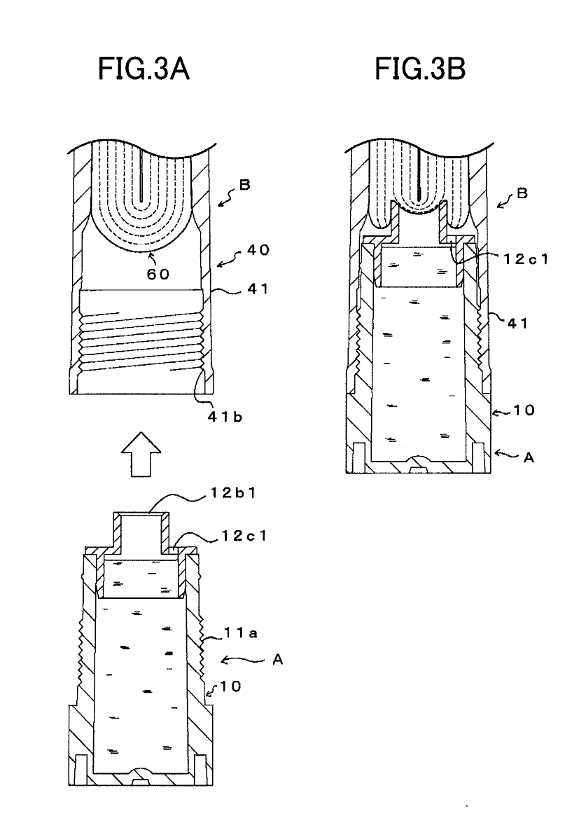

To explain more detailedly, as shown in FIGS. 3(a) and 3(b), the ink tank 10 the ink discharge port 12b1 of which is directed upward is screwed from the downside of the stem 40 the opening at the rear end of which is directed downward and the ink discharge port 12b1 is pressed on a rear end of the inner fiber 60 in the stem 40.

At this time, the inner fiber 60 in the stem 40 is pressed by the ink discharge port 12b1 of the ink tank 10 from the rear side. However, since the outside face of the writing part 61 integrated with the inner fiber 60 is fitted to the annular protrusion 43a with the outside face hardened by the setting agent x and its fitting force is also assisted by the restoring force of the inner fiber that tries to restore to the original condition from the folded condition, the inner fiber 60 is never displaced forward and the writing part 61 is never protruded from a constant position.

When the writing part 61 of the encapsulated fiber type writing instrument B is directed downward, ink M in the ink tank 10 is discharged into the inner fiber 60 in the stem 40 by its own weight.

At this time, since air in the stem 40 is taken in the ink tank 10 from the vent 12c1 as the ink M is discharged from the ink tank 10, the ink M in the ink tank 10 is smoothly discharged into the ink tank 10.

In addition, as the ink discharge port 12b1 of the ink tank 10 is touched to the rear end of the inner fiber 60 in the stem 40, the ink M can be prevented from being left in the ink tank 10 by surface tension and others and most of the ink M in the ink tank 10 can permeate the inner fiber 60.

Writing can be performed with the encapsulated fiber type writing instrument B without difficulty with the ink tank 10 mounted at the rear end of the stem 40 in place of the tail cotter 50.

Depending upon a user's choice, the ink tank 10 is removed and the original tail cotter 50 may also be mounted again.

1. An ink replenishment cartridge, comprising:
an ink tank provided with an ink discharge port;
ink filled in the ink tank; and
a closing cap detachably mounted on the ink tank to close the ink discharge port,
wherein the ink tank is installed with the ink discharge port communicating with an opening at a rear end of a stem of a writing instrument from which a detachable tail cotter is removed;
a small-diameter part is provided on the side of a front end of the ink tank;
the ink discharge port is provided inside the small-diameter part;
a vent is provided outside the small-diameter part; and
the vent is closed by the closing cap.

2. The ink replenishment cartridge according to claim 1,
wherein the ink tank is inserted into the opening at the rear end of the stem of the writing instrument; and
the ink discharge port is touched to inner fiber in the stem.

3. (canceled)

4. An encapsulated fiber type writing instrument that enables attaching and detaching of the ink replenishment cartridge into/from the opening at the rear end of the stem when the tail cotter is removed using the ink replenishment cartridge according to claim 1,
wherein inner fiber folded in two is encapsulated in the stem.

5. An encapsulated fiber type writing instrument that enables attaching and detaching of the ink replenishment cartridge into/from the opening at the rear end of the stem when the tail cotter is removed using the ink replenishment cartridge according to claim 2,
wherein the inner fiber folded in two is encapsulated in the stem.

6. (canceled)

7. The ink replenishment cartridge according to claim 1, comprising:
a corner part touched to a curved part of an inside face at a front end of the closing cap overall and formed on a front end face of the ink discharge port.

8. The ink replenishment cartridge according to claim 7, comprising:
packing in the shape of a washer which is provided around the small-diameter part in the ink tank, which closes the vent and which is pressed by the closing cap.
